(19) United States
(12) Patent Application Publication
(10) Pub. No.: US 2020/0118047 A1
(43) Pub. Date: Apr. 16, 2020

(54) SERVER, INFORMATION PROCESSING METHOD, AND NON-TRANSITORY STORAGE MEDIUM STORING PROGRAM

(71) Applicant: TOYOTA JIDOSHA KABUSHIKI KAISHA, Toyota-shi (JP)

(72) Inventors: Koichi SUZUKI, Miyoshi-shi (JP); Makoto AKAHANE, Nagoya-shi (JP)

(73) Assignee: TOYOTA JIDOSHA KABUSHIKI KAISHA, Toyota-shi (JP)

(21) Appl. No.: 16/539,349

(22) Filed: Aug. 13, 2019

(30) Foreign Application Priority Data
Oct. 11, 2018 (JP) 2018-192832

(51) Int. Cl. G06Q 10/02; G06F 16/22; G06N 20/00

(52) U.S. Cl. CPC G06Q 10/02; G06N 20/00; G06F 16/2282

(57) ABSTRACT

A server includes: a server communication unit configured to communicate with an external server that accepts a reservation of a vehicle from a terminal device of a first user, and acquire, from the external server, a start time of use specified in the reservation and user information on the first user; a server storage unit configured to store a first learning table and a schedule of the first user, the first learning table being a table in which user categories, intended use, and vehicle types are associated and accumulated; and a server control unit configured to extract, based on the user information and the start time, an intended use of the first user from the schedule, extract, based on the intended use of the first user and the user information, a used vehicle type from the first learning table, and output the used vehicle type to the external server.

### INCORPORATION BY REFERENCE

The disclosure of Japanese Patent Application No. 2018-192832 filed on Oct. 11, 2018 including the specification, drawings and abstract is incorporated herein by reference in its entirety.

### BACKGROUND

### 1. Technical Field

The present disclosure relates to a server, an information processing method, and a non-transitory storage medium storing a program.

### 2. Description of Related Art

Since a vehicle type can be selected when using car sharing, the user selects a vehicle type according to the number of passengers and the purpose of use. There is known a system that allows the user to reserve a car-sharing vehicle using a terminal device such as a smartphone. Some of such systems suggest a vehicle type to the user. For example, Japanese Patent Application Publication No. 2010-237980 (JP 2010-237980 A) discloses a technique that requests the user to enter the number of passengers, destination, purpose of use, and schedule on the terminal screen for selecting a vehicle that satisfies the user's need.

### SUMMARY

The technique disclosed in Japanese Patent Application Publication No. 2010-237980 (JP 2010-237980 A) requires the user to enter many items when reserving a vehicle.

The present disclosure provides a server, an information processing method, and a non-transitory storage medium storing a program that can propose a vehicle type that satisfies a user's request while reducing the time and effort for the user to enter items.

A first aspect of the disclosure provides a server. The server includes: a server communication unit configured to communicate with an external server that accepts a reservation of a vehicle from a terminal device of a first user, and acquire, from the external server, a start time of use specified in the reservation and user information on the first user; a server storage unit configured to store a first learning table and a schedule of the first user, the first learning table being a table in which user categories of a plurality of users, intended uses of the plurality of users, and vehicle types used by the plurality of users are associated and accumulated; and a server control unit configured to extract, based on the user information and the start time, an intended use of the first user from the schedule, extract, based on the intended use of the first user and the user information, a used vehicle type among the vehicle types used by the plurality of users from the first learning table, and output the used vehicle type to the external server.

A second aspect of the disclosure provides an information processing method. The information processing method includes: communicating with an external server that accepts a reservation of a vehicle from a terminal device of a first user; acquiring, from the external server, a start time of use specified in the reservation and user information on the first user; storing a first learning table and a schedule of the first user, the first learning table being a table in which user categories of a plurality of users, intended uses of the plurality of users, and vehicle types used by the plurality of users are associated and accumulated; extracting, based on the user information and the start time, an intended use of the first user from the schedule; extracting, based on the intended use of the first user and the user information, a used vehicle type among the vehicle types used by the plurality of users from the first learning table; and outputting the used vehicle type to the external server.

A third aspect of the disclosure provides a non-transitory storage medium storing a program that causes a server to communicate with an external server that accepts a reservation of a vehicle from a terminal device of a first user; acquire, from the external server, a start time of use specified in the reservation and user information on the first user; store a first learning table and a schedule of the first user, the first learning table being a table in which user categories of a plurality of users, intended uses of the plurality of users, and vehicle types used by the plurality of users are associated and accumulated; extract, based on the user information and the start time, an intended use of the first user from the schedule; extract, based on the intended use of the first user and the user information, a used vehicle type among the vehicle types used by the plurality of users from the first learning table; and output the used vehicle type to the external server.

According to the server, information processing method, and program according to one embodiment of the present disclosure, a vehicle type that satisfies a user's request can be provided in a user-selectable manner without requesting the user to enter many items. That is, a vehicle type that satisfies a user's request can be proposed while reducing the time and effort for the user to enter items.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing a schematic configuration of an information processing system according to one embodiment of the present disclosure;

FIG. 2 is a block diagram showing a schematic configuration of a vehicle;

FIG. 3 is a block diagram showing a schematic configuration of a terminal device;

FIG. 4 is a block diagram showing a schematic configuration of a server;

FIG. 5 is a diagram showing an example of a management database stored in the server;

FIG. 6 is a block diagram showing a schematic configuration of an external server;

FIG. 7 is a diagram showing an example of a reservation table stored in the external server;

FIG. 8 is a diagram showing an example of a user information table stored in the external server;

FIG. 9 is a diagram showing an example of a car sharing reservation screen;

FIG. 10 is a diagram showing an example of an image of vehicle type selection;

FIG. 11 is a diagram showing an example of a schedule screen;

FIG. 12 is a diagram showing an example of a first learning table;

FIG. 13 is a diagram showing an example of a second learning table;

FIG. 14 is an example of a sequence diagram showing an information processing method of the server; and

FIG. 15 is the sequence diagram continued from FIG. 14.

### DETAILED DESCRIPTION OF EMBODIMENTS

In the figures used in the description below, the same reference numeral is used for a component having the same configuration and the duplicated description is sometimes omitted.

(Configuration of Information Processing System)

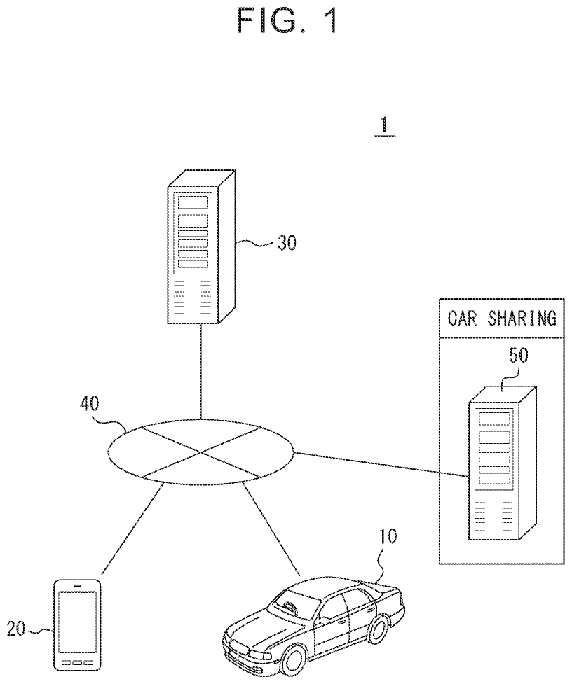

FIG. 1 is a diagram showing a schematic configuration of an information processing system 1. The information processing system 1 includes one or more vehicles 10, one or more terminal devices 20, and a server 30. Although one vehicle 10 and one terminal device 20 are shown in FIG. 1 for brevity of description, any number of vehicles 10 and any number of terminal devices 20 may be used in the information processing system 1. The vehicle 10, terminal device 20, and server 30 are connected to a network 40 such as the Internet. One or more terminal devices 20 and the server 30 can communicate with an external server 50 via the network 40. The external server 50 is the administrator of the system external to the information processing system 1. In this embodiment, the external server 50 manages car sharing reservations.

The vehicle 10 is, for example, an automobile but is not limited to an automobile; the vehicle 10 may be any vehicle on which a human can ride. In this embodiment, the vehicle 10 includes those used in car sharing. The terminal device 20 is a general-purpose mobile terminal such as a smartphone and a tablet terminal but is not limited to those terminals; for example, the terminal device 20 may be any mobile terminal such as a device dedicated to the information processing system 1. The terminal device 20 is carried by the user. The server 30 includes one server device or two or more server devices that can communicate with each other. The server 30 is installed, for example, in an information center that collects and analyzes the information on the vehicle 10. In this embodiment, it is assumed that there is one server 30 for brevity of description.

The user of the terminal device 20 can reserve the car-sharing vehicle 10 using a dedicated application (referred to as a reservation application in the description below) downloaded to the terminal device 20. In addition, the user of the terminal device 20 can select a vehicle type using the reservation application.

The information processing system 1 according to this embodiment provides a service that assists the user in reserving a vehicle. Broadly speaking, the information processing system 1 selects appropriate vehicle type candidates that are displayed when the user selects a vehicle type during the execution of the reservation application. Details of the user assistance executed by the information processing system 1 will be described later.

(Configuration of Vehicle)

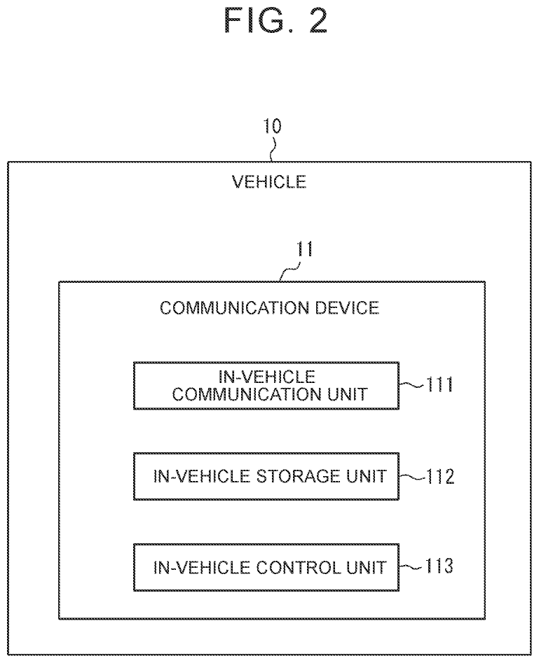

As shown in FIG. 2, the vehicle 10 includes a communication device 11. The communication device 11 is communicably connected to the vehicle 10 via an in-vehicle network such as Controller Area Network (CAN) or a dedicated line.

The communication device 11 may be an in-vehicle communication device such as a Data Communication Module (DCM). More specifically, the communication device 11 includes an in-vehicle communication unit 111, an in-vehicle storage unit 112, and an in-vehicle control unit 113.

The in-vehicle communication unit 111 includes a communication module for connection to the network 40. For example, the in-vehicle communication unit 111 may include a communication module conforming to a mobile communication standard such as 4G (4th Generation). In this embodiment, the communication device 11 is connected to the network 40 via the in-vehicle communication unit 111. The vehicle 10 may include one or more receivers compatible with any satellite positioning system. For example, the vehicle 10 may include a Global Positioning System (GPS) receiver. The communication device 11 may send the position information on the vehicle 10, obtained by the GPS receiver, to the server 30.

The in-vehicle storage unit 112 includes one or more memories. In this embodiment, the “memory” is a semiconductor memory, a magnetic memory, or an optical memory, but is not limited to those memories. Each memory included in the in-vehicle storage unit 112 may function as a main storage device, an auxiliary storage device, or a cache memory. The in-vehicle storage unit 112 stores any information used for the operation of the communication device 11. For example, the in-vehicle storage unit 112 may store programs such as system programs and application programs. The information stored in the in-vehicle storage unit 112 may be updatable, for example, with the information acquired from the network 40 via the in-vehicle communication unit 111.

The in-vehicle control unit 113 includes one or more processors. The “processor” in this embodiment is a general-purpose processor or a dedicated processor specialized for specific processing, but is not limited to those processors. The in-vehicle control unit 113 controls the whole operation of the communication device 11.

(Configuration of Terminal Device)

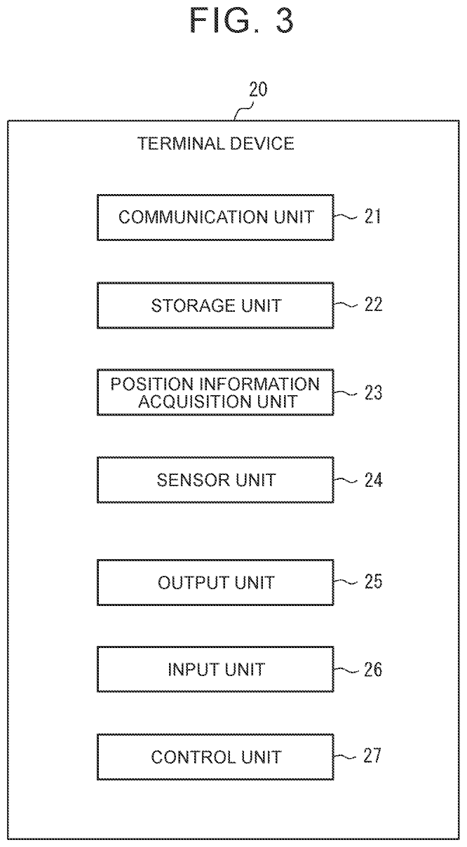

As shown in FIG. 3, the terminal device 20 includes a communication unit 21, a storage unit 22, a position information acquisition unit 23, a sensor unit 24, an output unit 25, an input unit 26, and a control unit 27.

The communication unit 21 includes a communication module for connection to the network 40. For example, the communication unit 21 may include a communication module conforming to a mobile communication standard such as 4G (4th Generation). In this embodiment, the terminal device 20 is connected to the network 40 via the communication unit 21.

The storage unit 22 includes one or more memories. Each memory included in the storage unit 22 may function as a main storage device, an auxiliary storage device, or a cache memory. The storage unit 22 stores any information used for the operation of the terminal device 20. For example, the storage unit 22 may store programs such as system programs and application programs and identification information such as the identification information on the terminal device 20 and the user identification information. The identification information on the terminal device 20 may be used as the user identification information. The information stored in the storage unit 22 may be updatable, for example, with the information acquired from the network 40 via the communication unit 21.

The position information acquisition unit 23 includes one or more receivers compatible with any satellite positioning system. For example, the position information acquisition unit 23 may include a GPS receiver. The position information acquisition unit 23 acquires the position information on the terminal device 20. The position information acquisition unit 23 may output the position information on the terminal device 20 to at least one of the server 30 and the external server 50.

The sensor unit 24 includes one or more sensors that detect the information on the terminal device 20 such as the information on the operation or the information on the surrounding environment. For example, the sensor unit 24 may include an acceleration sensor, an angular velocity sensor, a magnetic sensor, and an air pressure sensor. The sensor unit 24 may include not only those sensors but also any other sensor such as an illumination sensor, a temperature sensor, or an image sensor (camera). The sensor unit 24 acquires the information, detected by the sensors, as the sensor information. For example, the sensor information on the sensor unit 24 may include the information on the acceleration and the angular velocity of the terminal device 20 and the information on the magnetic field and the pressure around the terminal device 20.

The output unit 25 includes one or more output interfaces for outputting the information to the user. For example, the output interface included in the output unit 25 is a panel display that outputs the information as an image and a speaker that outputs the information as a voice but is not limited to those units.

The input unit 26 includes one or more input interfaces for detecting a user input. The input interface included in the input unit 26 is a touch screen provided integrally with the panel display of the output unit 25 and a microphone for receiving a voice input, but is not limited to those units.

The control unit 27 includes one or more processors. The processor may be a general-purpose processor or a dedicated processor specialized for specific processing. The control unit 27 may be a Central Processing Unit (CPU). The control unit 27 controls the whole operation of the terminal device 20.

The control unit 27 accumulates the position information on the terminal device 20, acquired by the position information acquisition unit 23, and the sensor information, acquired by the sensor unit 24, in the storage unit 22. The control unit 27 notifies, via the communication unit 21, at least one of the server 30 and the external server 50 about the user identification information and about the position information and the sensor information on the terminal device 20 accumulated in the storage unit 22. The control unit 27 may notify about the information at any time (for example, at a predetermined time interval). The control unit 27 may erase the position information and the sensor information on the terminal device 20, which have been notified to the server 30 and/or the external server 50, from the storage unit 22.

In addition, the control unit 27 executes the reservation application and the scheduler. As described above, the reservation application is an application for the user to reserve a vehicle using the terminal device 20. The scheduler is an application for registering and managing a user's schedule (activity or event plan).

(Configuration of Server)

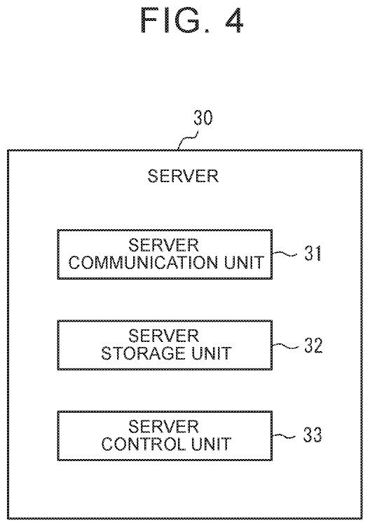

As shown in FIG. 4, the server 30 includes a server communication unit 31, a server storage unit 32, and a server control unit 33. The server 30 is a server device that provides traffic assistance to the user of the terminal device 20 and the user of the vehicle 10. The traffic assistance includes a search for a route to the destination and the provision of map information and traffic information. In this embodiment, the server 30 further manages the scheduler and provides selection assistance to the external server 50. The selection assistance includes the processing for appropriately narrowing the vehicle type so that the user of the terminal device 20 can easily select the type of a car-sharing vehicle.

In this embodiment, the vehicle type is specified as a combination of the type of the vehicle 10 (for example, compact car, sedan, minivan, station wagon, etc.) and the color of the body of the vehicle 10. Note that the vehicle type is not limited to the combination of type and color. For example, the individual name of the vehicle 10, the displacement, or the passenger capacity may be used as the vehicle type.

The server communication unit 31 includes a communication module for connection to the network 40. For example, the server communication unit 31 may include a communication module conforming to the wired Local Area Network (LAN) standard. In this embodiment, the server 30 is connected to the network 40 via the server communication unit 31.

The server storage unit 32 includes one or more memories. Each memory included in the server storage unit 32 may function as a main storage device, an auxiliary storage device, or a cache memory. The server storage unit 32 stores any information used for the operation of the server 30. For example, the server storage unit 32 may store programs such as system programs and application programs, the information such as the map information and the traffic information, and the management database that will be described later. The information stored in the server storage unit 32 may be updatable, for example, with the information acquired from the network 40 via the server communication unit 31.

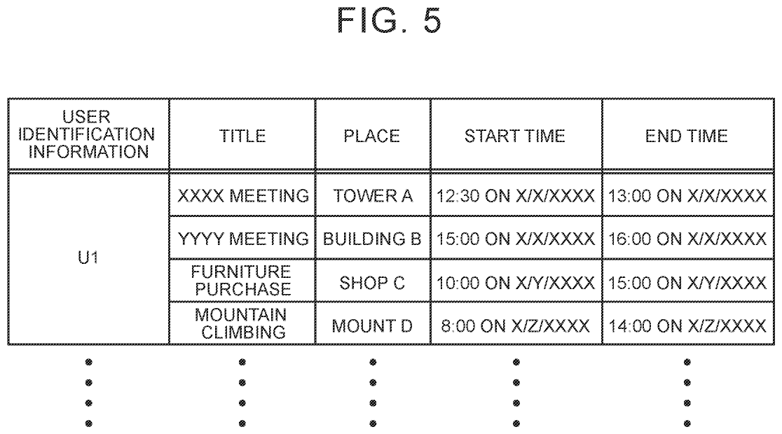

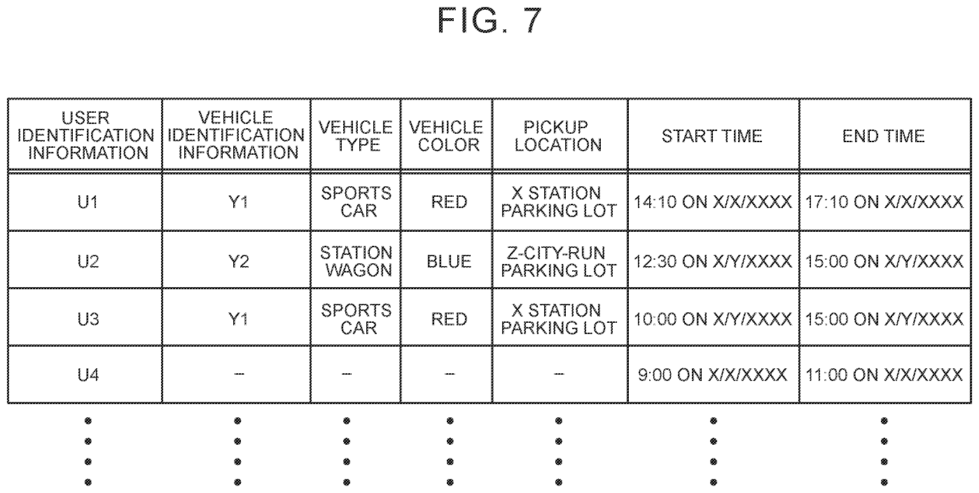

The management database includes the user's schedule table, for example, as shown in FIG. 5. The schedule table includes the user identification information, title indicating contents, place where the schedule is performed, start time, and end time. The user can activate the scheduler on the terminal device 20 to register a schedule and to manage a registered schedule (confirm, change, delete, etc.). In the example shown in FIG. 5, the user whose identification information is U1 (denoted as user U1 in the description below) is scheduled to have the xxxx meeting at tower A from 12:30 to 13:00 on X/X/XXXX. In addition, user U1 is scheduled to have the yyyy meeting in building B from 15:00 to 16:00 on X/X/XXXX. In addition, user U1 is scheduled to visit shop C to purchase furniture from 10:00 to 15:00 on X/Y/XXXX. In addition, user U1 is scheduled to climb mount D from 8:00 to 14:00 on X/Z/XXXX. The same user identification information is used by the server 30 and the external server 50 (see FIG. 7).

The server control unit 33 includes one or more processors. The processor may be a general-purpose processor or a dedicated processor specialized for specific processing. The server control unit 33 may be a CPU. The server control unit 33 controls the whole operation of the server 30.

In this embodiment, the server control unit 33 performs three types of processing: traffic assistance, schedule management, and selection assistance. As the traffic assistance processing, the server control unit 33 searches for a route to the destination based on the information such as the map information. As the schedule management processing, the server control unit 33 updates the management database in such a way that a new user schedule that has been acquired is reflected.

As the selection assistance processing, the server control unit 33 outputs a vehicle type, which was selected during the same or similar activity in the past, to the external server 50 via the server communication unit 31. In outputting such a vehicle type, the server control unit 33 extracts the information on user schedules, included in the management database, to get the information on the user activities. In the selection assistance processing, the server control unit 33 uses a first learning table and a second learning table that will be described later. The server control unit 33 may further search for a route to the destination based on the map information and may notify the user of a vehicle type suitable for the route that has been searched for. When a vehicle to be used by the user is determined, the server control unit 33 may reflect the selected vehicle type on the first learning table and the second learning table that will be described later.

In addition, the server control unit 33 may estimate the user's current means of transportation. For example, based on the position information and the sensor information on the terminal device 20, the server control unit 33 may estimate that the user's current means of transportation is walking, a bicycle, a passenger car, a bus, or a train. Any algorithm may be used to estimate the means of transportation. For example, the server control unit 33 may estimate that the user is moving on a train based on the position information and on the detection values of the acceleration sensor and the magnetic sensor. As the schedule management processing, the server control unit 33 may use the train delay information, acquired from the network 40, to determine whether the user is moving as planned.

(Configuration of External Server)

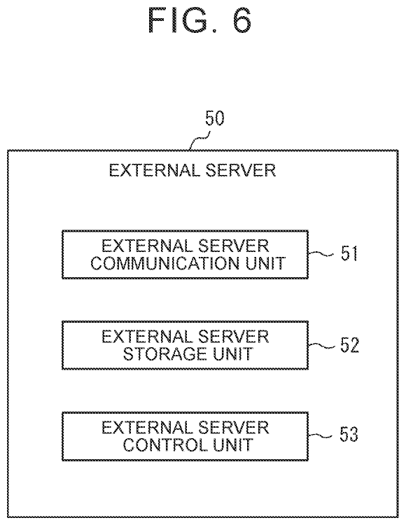

As shown in FIG. 6, the external server 50 includes an external server communication unit 51, an external server storage unit 52, and an external server control unit 53. As described above, the external server 50, a server device external to the information processing system 1, manages the reservation of the car-sharing vehicle 10. The external server 50 also manages the reservation application. The external server 50 can communicate with the terminal device 20 and the server 30 via the network 40.

The external server communication unit 51 includes a communication module for connection to the network 40. For example, the external server communication unit 51 may include a communication module conforming to the wired Local Area Network (LAN) standard. In this embodiment, the external server 50 is connected to the network 40 via the external server communication unit 51.

The external server storage unit 52 includes one or more memories. Each memory included in the external server storage unit 52 may function as a main storage device, an auxiliary storage device, or a cache memory. The external server storage unit 52 stores any information used for the operation of the external server 50. For example, the external server storage unit 52 may store programs such as system programs and application programs, the information such as the map information and the traffic information, and a car sharing database that will be described below. The car sharing database includes two tables: reservation table and user information table. The information stored in the external server storage unit 52 may be updatable, for example, with the information acquired from the network 40 via the external server communication unit 51.

The car sharing database includes a reservation table as shown in FIG. 7. The reservation table includes the identification information on the user who has made a reservation, the identification information on the reserved vehicle 10, the pickup location, the start time of use, and the time when the vehicle 10 is to be returned (end time). The user can activate the reservation application on the terminal device 20 to make a reservation for the vehicle 10 and to manage the reservation (e.g., confirmation, change, deletion, etc.). When the user reserves the vehicle 10 by the reservation application, the external server 50 reflects the reservation contents on the reservation table. In the example shown in FIG. 7, user U1 has made a reservation that user U1 will rent the vehicle 10 with the identification information Y1 (denoted as the vehicle 10-Y1 in the description below) at the X station parking lot at 14:10 on X/X/XXXX and will return the vehicle by 17:10. The vehicle 10-Y1 is a red sports car. User U2 has made a reservation that user U2 will rent the vehicle 10-Y2 at the Z-city-run parking lot at 12:30 on X/Y/XXXX and will return the vehicle by 15:00. The vehicle 10-Y2 is a blue station wagon type car. User U3 has made a reservation that user U3 will rent the vehicle 10-Y1 at the X station parking lot at 10:00 on X/Y/XXXX and will return the vehicle by 15:00. Note that, even before the user determines the vehicle type of the vehicle 10, the information already entered by the user using the reservation application may be reflected in the reservation table. In the example shown in FIG. 7, user U4 has made a reservation that user U4 will rent the vehicle 10 from 9:00 to 11:00 on X/X/XXXX, but the vehicle type of the vehicle 10 and the pickup location have yet not been determined.

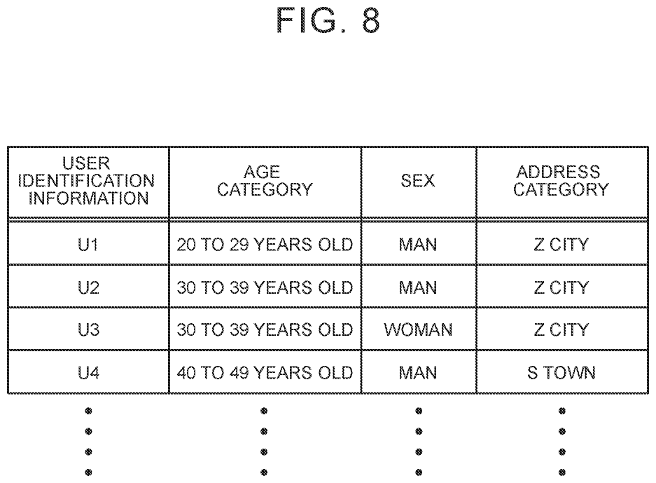

As shown in FIG. 8, the car sharing database includes a user information table that includes the information on the users who use car sharing. The user information table includes the user identification information, the age category, the sex, and the address category. The information on each item of the user information table is provided by the user, for example, when the user uses car sharing for the first time. In the example shown in FIG. 8, user U1 is a 20-to-29-year-old man living in Z city. User U2 is a 30-to-39-year-old man living in Z city. User U3 is a 30-to-39-year-old woman living in Z city. User U4 is a 40-to-49-year-old man living in S town. Although the age category is categorized into age ranges of 10 years in the example shown in FIG. 8, the age range of one category is not limited to a specific range. Moreover, though categorized by municipality in the example of FIG. 8, the address categorization is not always based on municipality. Note that the car sharing database may include not only the reservation table and the user information table but also the information on all the vehicles 10 available for car sharing. The information on all the vehicles 10 may be a table in which the vehicle 10 and the parking place of the vehicle 10 are associated.

The external server control unit 53 includes one or more processors. The processor may be a general-purpose processor or a dedicated processor specialized for specific processing. For example, the external server control unit 53 may be a CPU. The external server control unit 53 controls the whole operation of the external server 50.

The external server control unit 53 receives various types of information notified from the vehicle 10 and the terminal device 20 via the external server communication unit 51. For example, the external server control unit 53 receives the user identification information and the reservation contents of the car-sharing vehicle 10 from the terminal device 20. As described above, the same user identification information is used not only by the terminal device 20 and the external server control unit 53 but also by the server 30.

(Example of Display Screen)

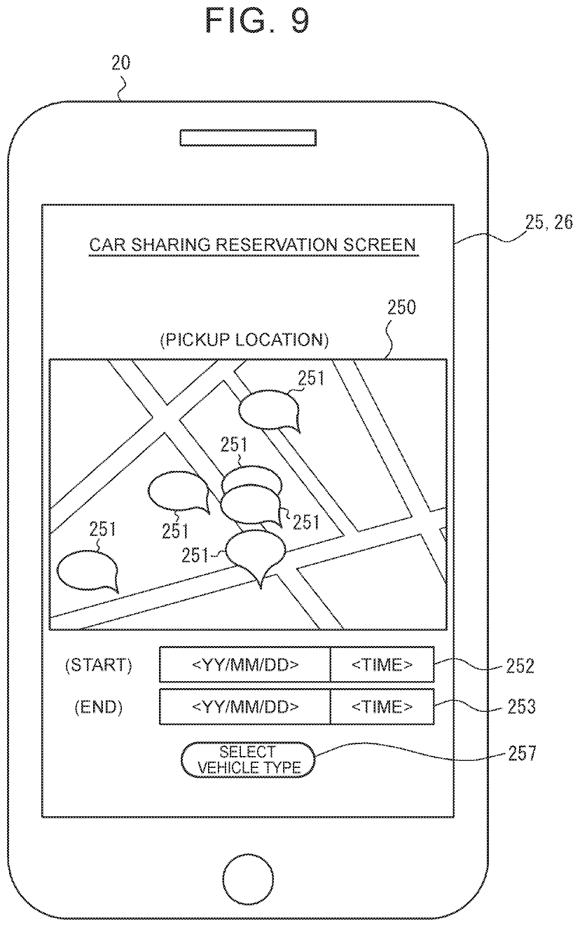

FIG. 9 shows an example of the car sharing reservation screen displayed on the terminal device 20. The car sharing reservation screen is displayed, for example, on a touch panel display in which the output unit 25 and the input unit 26 are integrated. The car sharing reservation screen includes a pickup location selection area 250 for selecting a pickup location, a start time entry area 252 for entering a start time, and an end time entry area 253 for entering an end time. The pickup location selection area 250 shows the map of the parking places 251 of the car-sharing vehicle 10 that are present near the user's current location or the designated place. The designated place is a place designated in advance by the user; for example, a home or a workplace. In the example shown in FIG. 9, each parking place 251 is shown by the image of a pin. The user touches one of the parking places 251 in the pickup location selection area 250 to designates it as the pickup location. However, in car sharing, the vehicle 10 may not always be available at a pickup location touched by the user. In such a case, the user may select the available vehicle 10 parked near the pickup location that the user touched. That is, the user touches one of the parking places 251 in the pickup location selection area 250 to designate the area where the user can get in the vehicle 10. The user can enter the start time in the start time entry area 252. The user can enter the end time in the end time entry area 253. In this embodiment, the time may further include the date. The pickup location selection area 250 does not always have to display a map. For example, the pickup location selection area 250 may display a list of addresses of the parking places 251 in the pulldown menu to allow the user to select one of them. The entry of the end time may be omitted.

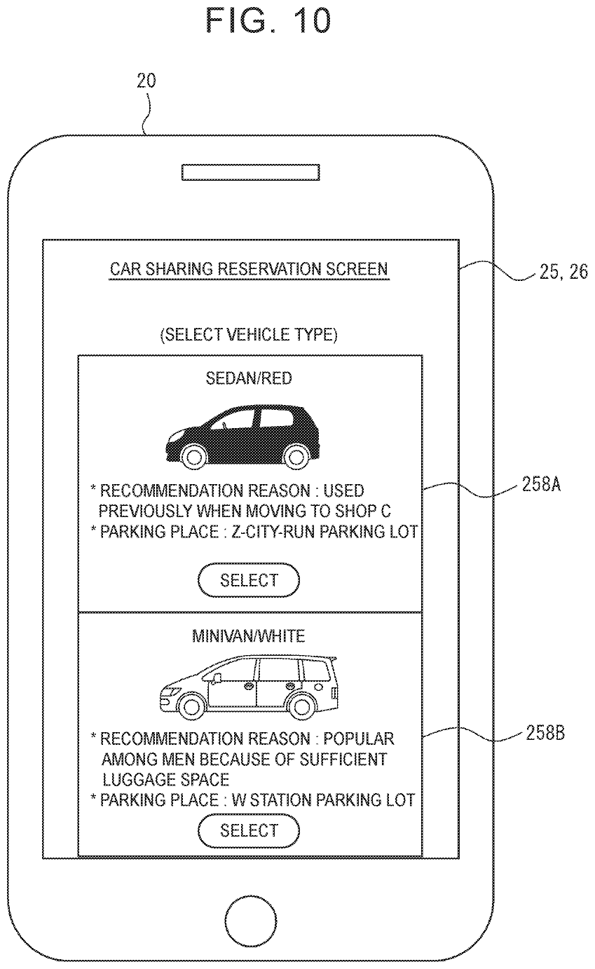

Next, the user touches the Select Vehicle Type button 257 to select the vehicle type of the vehicle 10 that the user wants to use. FIG. 10 is a diagram showing an example of the vehicle type selection image displayed on the terminal device 20. The vehicle type selection image includes the images of a plurality of candidate vehicles 10 and their description (hereinafter referred to as the candidate vehicle display). The user can select which vehicle 10 to use by touching one of the Select buttons attached to the candidate vehicle displays. In the example shown in FIG. 10, the vehicle 10 of a candidate vehicle display 258A is a red sedan, and the vehicle 10 of a candidate vehicle display 258B is a white minivan. The user can view the other candidate vehicles 10 by scrolling the car sharing reservation screen. That is, the candidate vehicle 10 is not limited to two candidates such as those shown in FIG. 10; for example, there may be three or more candidate vehicles 10. Although the details will be described later, the server 30 outputs, to the external server 50, the information on the vehicle type that was selected in the past for the same or similar activity. The external server 50 includes the vehicle types, received from the server 30, in the vehicle type selection image as shown in FIG. 10.

In the example shown in FIG. 10, the candidate vehicle display 258A and the candidate vehicle display 258B include not only the description of the vehicle type and the image of the external view of the vehicle 10 but also the recommendation reason and the parking place. It is assumed in the description below that user u1 is scheduled to move to shop C. The server 30 generates the recommendation reason as follows. For example, based on a second learning table that will be described later, the server 30 determines that the user used the red sedan, displayed in the candidate vehicle display 258A, when moving to shop C in the past and, based on this determination, generates the recommendation reason indicating that the red sedan was used. In addition, based on the car sharing database, the external server 50 determines that the parking place of the red sedan, displayed in the candidate vehicle display 258A, is the Z-city-run parking lot and, based on this determination, adds this information to the candidate vehicle display 258A. In addition, based on a first learning table that will be described later, the server 30 determines that the white minivan displayed in the candidate vehicle display 258 B is statistically most frequently used in moving to shop C and, based on this determination, generates the recommendation reason indicating that the white minivan is popular. Furthermore, based on the car sharing database, the external server 50 determines that the parking place of the white minivan, displayed in the candidate vehicle display 258B, is the W station parking lot and, based on this determination, adds this information to the candidate vehicle display 258B.

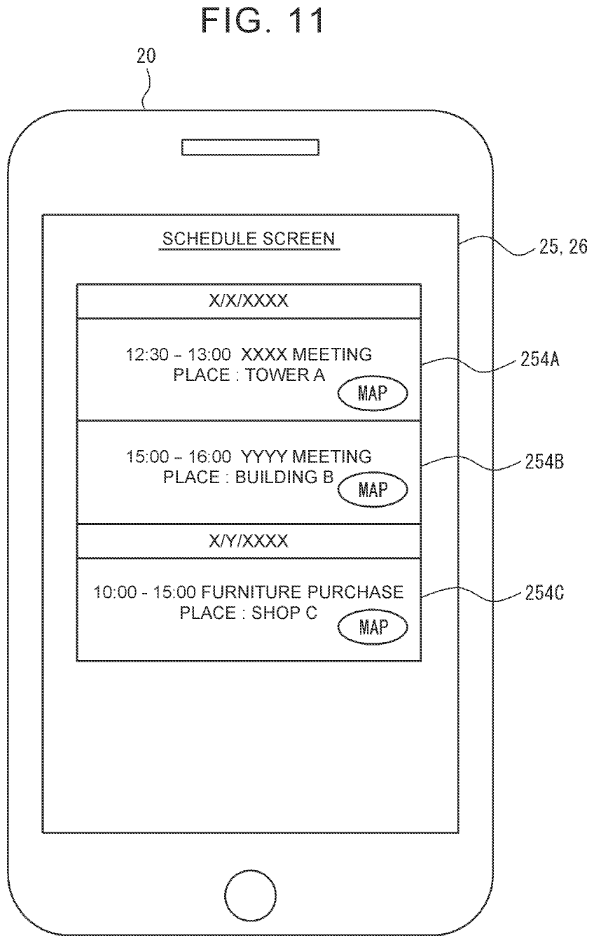

FIG. 11 shows an example of the user's schedule screen displayed on the terminal device 20. The schedule screen is displayed, for example, on a touch panel display in which the output unit 25 and the input unit 26 are integrated. The user can touch one displayed schedule (for example, xxxx meeting) to display the editing screen for editing its contents. The user can also touch a portion on the screen where the schedule is not displayed (for example, a blank peripheral portion of the screen) to display a new registration screen for entering a new schedule. In the example shown in FIG. 11, the schedule screen displays the user's schedules in order of start times. More specifically, the schedule screen displays the first activity schedule (xxxx meeting at tower A at 12:30 to 13:00 on X/X/XXXX) in an area 254A. The schedule screen also displays a second activity schedule (yyyy meeting in building B at 15:00 to 16:00 on X/X/XXXX) in an area 254B. The schedule screen also displays a third activity schedule (purchase of furniture at shop C at 10:00 to 15:00 on X/Y/XXXX) in an area 254C. The schedule screen includes the image (MAP button) for displaying the map of the place of each of the first activity schedule, second activity schedule, and third activity schedule. In the example shown in FIG. 11, when the user touches the MAP button included in the area 254B, the place of the second activity schedule is shown on the map.

The scheduler executed on the terminal device 20 displays the schedule screen, shown above, based on the management database stored in the server 30. The user manages his or her own schedule using the scheduler. Note that, while the scheduler communicates with the server 30, the reservation application communicates with the external server 50 as described above. That is, the scheduler and the reservation application are managed by different server devices. In this embodiment, the server 30 and the external server 50 automatically associate the user's schedule with the reservation of the car-sharing vehicle 10, select a vehicle type that satisfies the user's request, and cause the terminal device 20 to display the selected vehicle type in the vehicle type selection image as shown in FIG. 10. For selecting an appropriate vehicle type, the server 30 uses the learning tables (described below) included in the management database. Since data is accumulated in the learning tables gradually over time, a more appropriate vehicle type can be selected as the time elapses.

(Learning Tables)

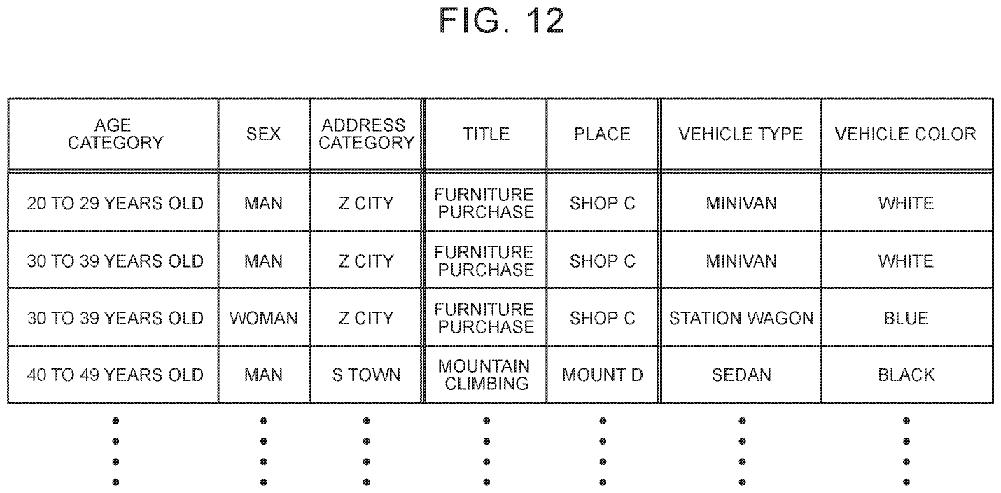

FIG. 12 is a diagram showing an example of a first learning table. The first learning table is stored in the server storage unit 32. The first learning table is included in the management database managed by the server control unit 33. The first learning table includes the age category, the sex, and the address category of a car sharing user, the title and the place of a user's schedule, and the type and the color of the vehicle 10 the user used in car sharing in the past.

Age Category, Sex, and Address Category of a user, which are items included in the first learning table, correspond to the items of the same names in the user information table managed by the external server 50. The server 30 acquires the age category, the sex, and the address category of a user from the user information table managed by the external server 50 with these items associated with the user identification information. The age category, the sex, and the address category of a user may be collectively referred to as the “user category”. The server 30 may store the first learning table in a manner that does not identify the personal information on each user.

Title and Place of a user's schedule, which are items included in the first learning table, correspond to the items of the same names in the schedule table managed by the server 30. The server 30 extracts the title and the place of a user's schedule from the schedule table with these items associated with the user identification information. The title and the place of a schedule may be collectively referred to as “intended use”.

Vehicle Type and Vehicle Color of the vehicle 10 used by the user in car sharing, which are items included in the first learning table, correspond to the items of the same names in the reservation table managed by the external server 50. The server 30 acquires the vehicle type and the vehicle color of the vehicle 10 used by the user in car sharing from the reservation table managed by the external server 50 with these items associated with the user identification information. As described above, the type and the color of the vehicle 10 are collectively referred to as “vehicle type”.

The server 30 configures the first learning table by associating the data extracted from the schedule table with the data acquired from the external server 50 using the user identification information and stores the configured first learning table in the server storage unit 32. When the user determines the vehicle 10 to be used for car sharing using the reservation application, the server 30 may acquire the information on the vehicle type from the external server 50 for updating the first learning table.

In the example shown in FIG. 12, a 20-to-29-year-old man living in Z city and a 30-to-39-year-old man living in Z city used the white minivan type vehicle 10 when purchasing furniture at shop C. A 30-to-39-year-old women living in Z city used the white station-wagon type vehicle 10 when purchasing furniture at shop C. A 40-to-49-year-old man living in S town used the black sedan type vehicle 10 when climbing mount D. The server 30 can determine the tendency of the selection of a vehicle type used in the past in the same or similar activity based on the first learning table. For example, the server 30 may statistically classify the used vehicle types by activity. When it is determined that the black sedan type vehicle 10 was used for climbing mount D regardless of the age category and the sex, the server 30 may output, to the external server 50, the information indicating the black sedan type was used for climbing mount D. The server 30 may output, to the external server 50, the information indicating that a different vehicle type was used according to the user's age category and the sex. The server 30 may output the information on a plurality of vehicle types to the external server 50. For example, when it is determined that the vehicle was used frequently in the order of the white minivan type, blue station-wagon type, and white sedan type for the furniture purchase at shop C, the server 30 may output the information on these three vehicle types to the external server 50.

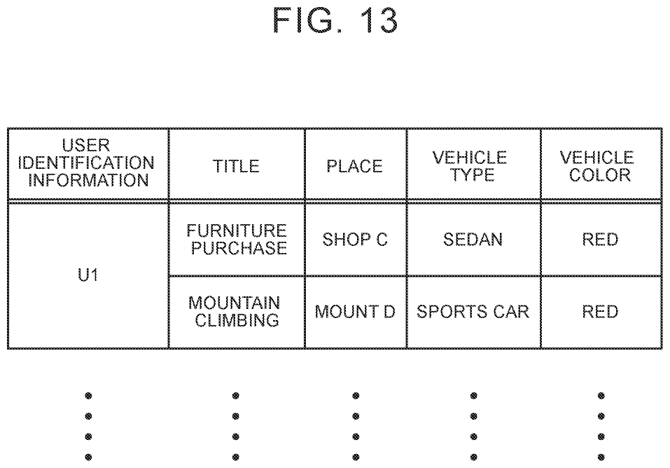

FIG. 13 is a diagram showing an example of a second learning table. The second learning table is stored in the server storage unit 32. The second learning table is included in the management database managed by the server control unit 33. The second learning table includes the user identification information, the title and the place of a user's schedule, and the type and the color of the vehicle 10 used by the user in car sharing in the past.

Title and Place (intended use) of a user's schedule, which are items included in the second learning table, correspond to the items of the same names in the schedule table managed by the server 30. The server 30 extracts the intended use from the schedule table with the intended use associated with the user identification information.

Vehicle Type and Vehicle Color (vehicle type) of the vehicle 10 used by the user in car sharing, which are items included in the second learning table, correspond to the items of the same names in the reservation table managed by the external server 50. The server 30 acquires the vehicle type of the vehicle 10 used by the user in car sharing from the external server 50 with the vehicle type associated the user identification information.

The server 30 configures the second learning table by associating the data extracted from the schedule table with the data acquired from the external server 50 using the user identification information and stores the configured second learning table in the server storage unit 32. Unlike the first learning table, the information in the second learning table identifies the personal information on each user. When the user determines the vehicle 10 to be used for car sharing using the reservation application, the server 30 may acquire the information on the vehicle type from the external server 50 for updating the second learning table.

In the example shown in FIG. 13, the second learning table indicates that user U1 used the red sedan type vehicle 10 when purchasing furniture at shop C. The second learning table also indicates that user U1 used the red sports car type vehicle 10 when climbing mount D. Therefore, based on the second learning table, the server 30 can determine the vehicle type that a particular user used in the past for the same or similar activity. That is, by referring to the second learning table, the server 30 can determine the vehicle type of a particular user's preference by activity. When it is determined from the external server 50 that the car sharing reservation user is user U1 and that the user will use the vehicle for climbing mount D, the server 30 may output, to the external server 50, the information indicating that the vehicle type selected by the user for the same activity in the past is a red sports car type vehicle. At this time, the server 30 may add the instruction information (for example, higher priority) to the vehicle type determined based on the second learning table (vehicle type on which a user's preference is reflected) to indicate that the priority is higher than that of the vehicle type determined based on the first learning table. In this case, the vehicles 10 may be displayed in the vehicle type selection image in the order according to the priority.

(Communication Processing)

When the user reserves the vehicle 10 using the reservation application, the server 30 performs the communication processing (information processing method) described below to propose a vehicle type that satisfies the user's requirements while reducing the entry time and effort required for the user.

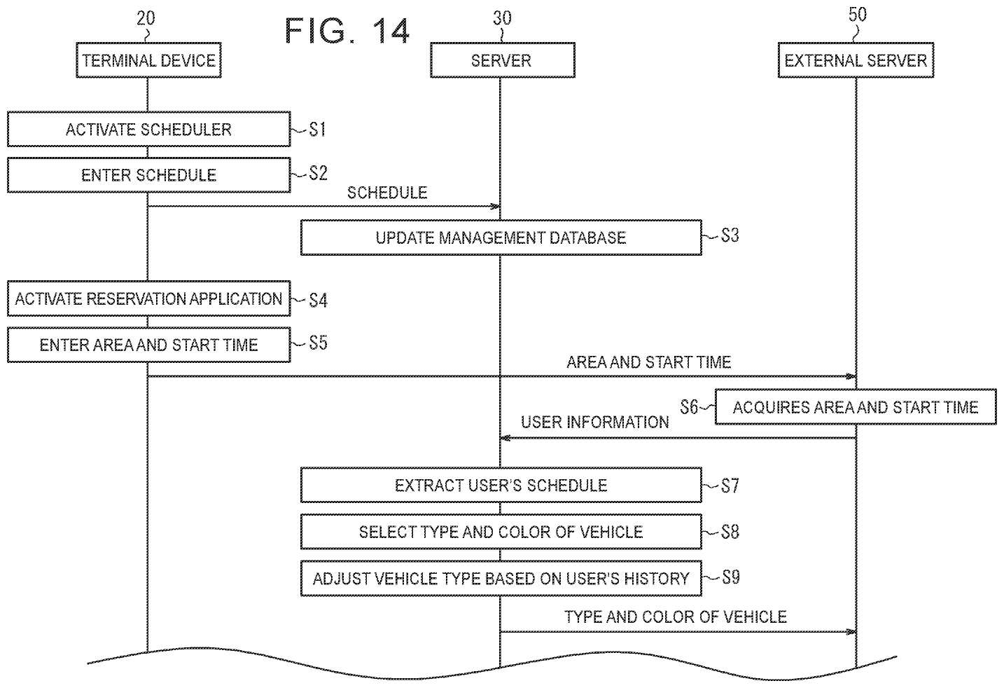

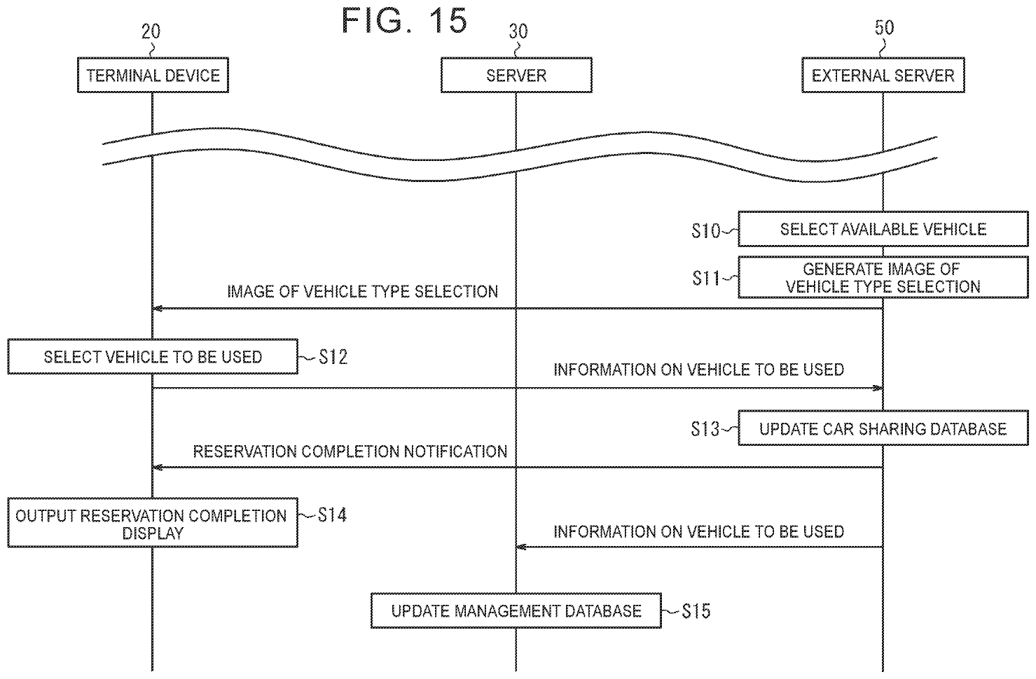

FIG. 14 and FIG. 15 are an example of the sequence diagram showing the communication processing performed by the server 30 with the terminal device 20 and the external server 50.

The terminal device 20 activates the scheduler according to a user's operation (for example, a tap on the scheduler icon) (step S1).

When the user enters a schedule (for example, a title, a place, a start time, and an end time are entered) (step S2), the terminal device 20 outputs the received new schedule to the server 30 to register it.

When the new schedule is received from the terminal device 20, the server 30 reflects the new schedule on the schedule table included in the management database.

That is, the server 30 updates the management database (step S3).

The terminal device 20 activates the reservation application in accordance with a user's operation (for example, a tap on the reservation application icon) (step S4).

The reservation application executed on the terminal device 20 displays the car sharing reservation screen. The terminal device 20 acquires the information entered by the user. At this time, at least the area and the start time are entered (step S5). The area is an area where the user can get in the vehicle 10. The area is defined in a predetermined range including the pickup location designated by the user. The predetermined range may be defined, for example, within a radius of 2 km from the pickup location designated by the user. The predetermined range may also be defined as being the same municipality as the pickup location designated by the user. The terminal device 20 outputs the area and the start time to the external server 50.

The external server 50 acquires the area and the start time from the terminal device 20 (step S6). After that, the external server 50 outputs the start time and the user information (information about the user) to the server 30. The user information includes the user identification information, the age category, the sex, and the address category included in the above-mentioned user information table.

The server 30 extracts the schedule of the user of the terminal device 20 based on the user information acquired from the external server 50 (step S7). That is, the server 30 extracts the user's intended use of car sharing.

The server 30 selects the type and the color of the vehicle 10 that is statistically determined to be suitable for the user's intended use based on the user information, the extracted user's schedule, and the first learning table (step S8).

The server 30 further selects the type and the color of the vehicle 10 determined to match the user's preference based on the user information, the extracted user's schedule, and the second learning table. That is, based on the user's history, the server 30 adjusts the vehicle type to be selected (step S9). Then, the server 30 outputs the selected type and the color of the vehicle 10 to the external server 50.

The external server 50 selects the vehicle 10 that matches the type and the color selected by the server 30 and that is available in the area, where the user makes the reservation, and at the start time based on the information on all the vehicles 10 and the reservation table (step S10).

The external server 50 generates the image of a vehicle type selection for the vehicle 10 selected in step S10 (step S11). Then, the external server 50 outputs the generated image of the vehicle type selection to the terminal device 20.

When the user selects vehicle 10 to be used (step S12), the terminal device 20 outputs the information on the user-selected vehicle to the external server 50.

The external server 50 acquires the information on the vehicle 10 to be used by the user from the terminal device 20 and reflects the acquired information on the reservation table. That is, the external server 50 updates the car sharing database (step S13). After that, the external server 50 outputs, to the terminal device 20, a reservation completion notification indicating that the reservation of the vehicle 10 is completed.

When the reservation completion notification is acquired from the external server 50, the terminal device 20 outputs the reservation completion display (step S14).

The reservation completion display is a display notifying the user that the reservation of the vehicle 10 is completed.

After updating the car sharing database, the external server 50 outputs the information on the vehicle 10 to be used by the user, which has been acquired from the terminal device 20, to the server 30. The information on the vehicle 10 that the external server 50 outputs to the server 30 includes at least the information on the vehicle type.

The server 30 acquires, from the external server 50, the information on the vehicle type that the user has determined to use. The server 30 reflects the acquired vehicle type information on the first learning table and the second learning table. That is, the server 30 updates the management database (step S15).

As described above, when the user reserves the vehicle 10, the server 30 of the information processing system 1 can propose a vehicle type that satisfies the requirements of the user using the first learning table in which the user category, the intended use, and the used vehicle type are associated with one another. At this time, the user does not have to enter the information, such as the intended use and the preference in vehicle type, on the car sharing reservation screen. That is, the server 30 of the information processing system 1 can reduce the time and effort required for the user to enter such information.

In addition, as in the above embodiment, when the user reserves the vehicle 10, the server 30 can propose a vehicle type that satisfies the requirements of the user using the second learning table in which the intended use and the used vehicle type are associated and accumulated for each user. That is, the server 30 can propose a vehicle type tailored to the personal preference of the user.

In addition, as in the above embodiment, when the information on the vehicle type that the user has determined to use is acquired from the external server 50, the server 30 updates the first learning table and the second learning table in such a way that the vehicle type the user has determined to use is reflected on those tables. The server 30 accumulates data in the first learning table and the second learning table in this way, improving the user's satisfaction with a proposed vehicle type.

Although the present disclosure has been described with reference to the drawings and embodiment, it should be noted that those skilled in the art can easily make various changes and modifications based on the present disclosure. Therefore, it is to be noted that these changes and modifications are within the scope of the present disclosure. For example, it is possible to relocate the functions included in each unit or each step in such a way that they are not logically contradictory, and it is possible to combine a plurality of units or steps into one or to divide a plurality of units or steps.

For example, the “user category” described above may include not only the age category, the sex, and the address category of a user but also other items (for example, the number of times the user used car sharing). The user category may not include some items (for example, the address category). The “intended use” described above may include not only the title and the place of a schedule but also other items (for example, companions). The intended use may not include some items (for example, place). In this case, the server 30 may extract the information on a companion, which can be added to the intended use, from the contents entered by the user using the scheduler (for example, “Meal with Mr. A” included in the title). The server 30 may obtain the information on a companion by extracting a user having the same contents (for example, a user with the same title, same place, same start time, and same end time) from the schedule table. In addition, when the scheduler has a function that allows a plurality of users to share a schedule, the server 30 may assume that a user is a companion when sharing has been set for that user.

The information processing system 1 may be configured to include the external server 50. Note that the configuration of each of the vehicle 10, the terminal device 20, the server 30 and the external server 50 described above is exemplary. In other words, the vehicle 10, the terminal device 20, the server 30 and the external server 50 may not include all the components shown in FIG. 2, FIG. 3, FIG. 4 and FIG. 6. The vehicle 10, the terminal device 20, the server 30 and the external server 50 may have components other than those shown in FIG. 2, FIG. 3, FIG. 4 and FIG. 6.

The server 30 and the terminal device 20 cooperate with each other in various types of processing, and the sharing of processing in the above embodiment is an example. For example, the terminal device 20 may perform at least a part of processing performed by the server 30 in the above embodiment. Similarly, the server 30 may perform at least a part of processing performed by the terminal device 20 in the above embodiment.

The server 30 and the external server 50 cooperate with each other in various types of processing, and the sharing of processing in the above embodiment is an example. For example, the external server 50 may perform at least a part of processing performed by the server 30 in the above embodiment. Similarly, the server 30 may perform at least a part of processing performed by the external server 50 in the above embodiment.

It is possible to allow the processor mounted on a general-purpose electronic device (corresponding to the terminal device 20 and the server 30), such as a mobile information terminal and a server device, to function as the control unit 27 and the server control unit 33 described above. More specifically, to allow the processor to function as described above, the program describing the processing for implementing the functions of the electronic device is stored in the storage unit (memory) of the electronic device and, then, the processor of the electronic device reads this program for execution.

What is claimed is:

1. A server comprising:
a server communication unit configured to
communicate with an external server that accepts a reservation of a vehicle from a terminal device of a first user, and
acquire, from the external server, a start time of use specified in the reservation and user information on the first user;
a server storage unit configured to store a first learning table and a schedule of the first user, the first learning table being a table in which user categories of a plurality of users, intended uses of the plurality of users, and vehicle types used by the plurality of users are associated and accumulated; and
a server control unit configured to
extract, based on the user information and the start time, an intended use of the first user from the schedule,
extract, based on the intended use of the first user and the user information, a used vehicle type among the vehicle types used by the plurality of users from the first learning table, and
output the used vehicle type to the external server.

2. The server according to claim 1, wherein
the server control unit is configured to, when information on a use-determined vehicle type that the first user has determined to use during the reservation is acquired from the external server via the server communication unit, update the first learning table in such a way that the information on the use-determined vehicle type is reflected.

3. The server according to claim 1, wherein
the server storage unit is configured to store a second learning table in which the intended use of the first user and a use-determined vehicle type that the first user has determined to use are associated and accumulated, and
the server control unit is configured to
extract, based on the intended use of the first user extracted from the schedule and on the user information, the use-determined vehicle type from the second learning table, and
output the extracted use-determined vehicle type to the external server.

4. The server according to claim 2, wherein
the server storage unit is configured to store a second learning table in which the intended use of the first user and the use-determined vehicle type are associated and accumulated, and
the server control unit is configured to
extract, based on the intended use of the first user extracted from the schedule and on the user information, the use-determined vehicle type from the second learning table, and
output the extracted use-determined vehicle type to the external server.

5. The server according to claim 3, wherein
the server control unit is configured to, when information on the use-determined vehicle type that the first user has determined to use during the reservation is acquired from the external server via the server communication unit, update the second learning table in such a way that the information on the use-determined vehicle type is reflected.

6. The server according to claim 1, wherein
the server storage unit is configured to store the first learning table in which the user categories of the plurality of users who use car sharing, the intended uses of the plurality of users, and the vehicle types used by the plurality of users are associated and accumulated in a manner that does not identify personal information on the plurality of users.

7. An information processing method comprising:
communicating with an external server that accepts a reservation of a vehicle from a terminal device of a first user;
acquiring, from the external server, a start time of use specified in the reservation and user information on the first user;
storing a first learning table and a schedule of the first user, the first learning table being a table in which user categories of a plurality of users, intended uses of the plurality of users, and vehicle types used by the plurality of users are associated and accumulated;
extracting, based on the user information and the start time, an intended use of the first user from the schedule;
extracting, based on the intended use of the first user and the user information, a used vehicle type among the vehicle types used by the plurality of users from the first learning table; and
outputting the used vehicle type to the external server.

8. A non-transitory storage medium storing a program that causes a server to
communicate with an external server that accepts a reservation of a vehicle from a terminal device of a first user;
acquire, from the external server, a start time of use specified in the reservation and user information on the first user;
store a first learning table and a schedule of the first user, the first learning table being a table in which user categories of a plurality of users, intended uses of the plurality of users, and vehicle types used by the plurality of users are associated and accumulated;
extract, based on the user information and the start time, an intended use of the first user from the schedule;
extract, based on the intended use of the first user and the user information, a used vehicle type among the vehicle types used by the plurality of users from the first learning table; and
output the used vehicle type to the external server.
